(19) United States
(12) Patent Application Publication
(10) Pub. No.: US 2020/0277874 A1
(43) Pub. Date: Sep. 3, 2020

(54) AIRCRAFT PROPULSION SYSTEM HAVING HYBRID-ELECTRIC POWERPLANT AND COMBUSTION POWERPLANT

(71) Applicant: Pratt & Whitney Canada Corp., Longueuil (CA)

(72) Inventor: Jean Thomassin, Ste Julie (CA)

(73) Assignee: Pratt & Whitney Canada Corp., Longueuil (CA)

(21) Appl. No.: 16/707,566

(22) Filed: Dec. 9, 2019

Related U.S. Application Data
(60) Provisional application No. 62/821,367, filed on Mar. 20, 2019.
(60) Provisional application No. 62/812,348, filed on Mar. 1, 2019.

(51) Int. Cl. F01D 15/10; F02K 5/00

(52) U.S. Cl. CPC F01D 15/10; B64D 2027/026; F02K 5/00

(57) ABSTRACT

An aircraft propulsion system having dual powerplants is disclosed that includes a combustion powerplant on one wing of the aircraft and a hybrid-electric powerplant on the other wing of the aircraft, wherein the combustion powerplant includes a gas turbine turboprop engine and the hybrid-electric powerplant includes a heat engine and an electric motor that are arranged in either a parallel drive configuration or an in-line drive configuration.

### CROSS REFERENCE TO RELATED APPLICATIONS

This application claims the benefit of and priority to U.S. Provisional Patent Application No. 62/812,348, filed Mar. 1, 2019, and U.S. Provisional Patent Application No. 62/821,367, filed Mar. 20, 2019, the disclosures of each of which are hereby incorporated by reference in their entirety.

### BACKGROUND OF THE INVENTION

### 1. Field of the Invention

The subject invention is directed to an aircraft propulsion system having two different types of powerplants, and more particularly, to a commercial passenger aircraft having a propulsion system that includes a gas turbine turboprop for driving one air mover and a hybrid-electric powerplant for driving another air mover.

### 2. Description of Related Art

The level of air traffic continues to increase worldwide, leading to increased fuel consumption and air pollution. Consequently, efforts are underway to make aircraft more environmentally compatible through the use of specific types of fuel and/or by reducing fuel consumption through the use of more efficient drive systems.

For example, aircraft having mixed drive systems that include a combination of various types of engines are known for reducing pollutants and increasing efficiency. Some current combinations include reciprocating engines and jet engines, reciprocating engines and rocket engines, jet engines and rocket engines, or turbojet engines and ramjet engines.

While these mixed drive systems are useful, they are not readily adaptable for use on commercial passenger aircraft. However, hybrid-electric propulsion systems that provide power through a combustion engine and an electric motor are indeed adaptable for use with commercial passenger aircraft and can provide efficiency benefits including reduced fuel consumption. The subject invention is directed to an aircraft having such a propulsion system.

### SUMMARY OF THE DISCLOSURE

The subject invention is directed to a new and useful aircraft propulsion system having dual powerplants. The propulsion system includes a combustion powerplant and a hybrid-electric powerplant. The combustion powerplant delivers power to a first air mover for propelling the aircraft and the hybrid-electric powerplant delivers power to a second air mover for propelling the aircraft.

Preferably, the combustion powerplant includes a gas turbine turboprop engine, and the hybrid-electric powerplant includes a heat engine and an electric motor. The heat engine and the electric motor of the hybrid-electric powerplant can be arranged in either a parallel drive configuration or in an in-line drive configuration. The power delivery from the hybrid-electric powerplant can be about evenly split between the heat engine and the electric motor, or the power delivery from the hybrid-electric powerplant can be proportionally split between the heat engine and the electric motor.

It is envisioned that the heat engine of the hybrid-electric powerplant could be a rotary engine or a reciprocating engine of any fuel type with a configuration of turbomachinery elements, selected from a group consisting of a turbocharger, turbo-supercharger, or supercharger and exhaust recovery turbo compounding, which is mechanically, electrically, hydraulically or pneumatically driven.

A battery system provides energy to the electric motor of the hybrid-electric powerplant, and it is envisioned that the battery system could be located within the fuselage of the aircraft and/or within the wings of the aircraft or in any other location providing the required installation space and adjacency of the used electric power.

The subject invention is also directed to a new and useful commercial passenger aircraft that has a propulsion system with dual powerplants, which include a combustion powerplant associated with a first wing of the aircraft that delivers power to a first air mover for propelling the aircraft, and a hybrid-electric powerplant associated with a second wing of the aircraft that delivers power to a second air mover for propelling the aircraft. Preferably, the combustion powerplant includes a gas turbine turboprop engine and the hybrid-electric powerplant includes a heat engine and an electric motor that are arranged in either a parallel drive configuration or in an in-line drive configuration. The commercial passenger aircraft of the subject invention is the result of a modification to an existing aircraft having dual combustion powerplants, wherein a turboprop engine is associated with the left and right wings of the aircraft. By replacing the combustion powerplant associated with the right wing of the aircraft with a hybrid-electric powerplant that includes an electric motor and a heat engine, fuel consumption will be reduced.

The subject invention is also directed to a method of retrofitting an aircraft having a propulsion system with dual combustion powerplants, which includes the steps of removing at least a combustion powerplant from the aircraft, and then replacing the combustion powerplant that has been removed from the aircraft with a hybrid-electric powerplant, such that the aircraft has a combustion powerplant associated with one wing and a hybrid-electric powerplant associated with the other wing.

The subject invention is also directed to a method of retrofitting an aircraft having a propulsion system with combustion powerplants, which includes the steps of removing the existing combustion powerplants from the aircraft, and installing hybrid-electric powerplants on the aircraft, to improve the fuel efficiency of the propulsion system.

These and other features of the aircraft propulsion system of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those having ordinary skill in the art will readily understand how to make and use the subject invention without undue experimentation, preferred embodiments thereof will be described in detail herein below with reference to the figures wherein:

FIG. 1 is a top plan view of a commercial passenger aircraft having a propulsion system configured in accordance with a preferred embodiment of the subject invention, which includes a combustion powerplant associated with the left wing of the aircraft and a hybrid-electric powerplant associated with the right wing of the aircraft;

FIG. 2 is a front elevational view of the aircraft illustrated in FIG. 1;

FIG. 3 is a left side front elevational view of the aircraft illustrated in FIG. 1; and

FIG. 4 is a schematic representation of the propulsion system of the subject invention, which includes a combustion powerplant having a gas turbine engine and a hybrid-electric powerplant having an electric motor (eM) and a heat engine or motor (hM).

### DETAILED DESCRIPTION OF THE PREFERRED EMBODIMENTS

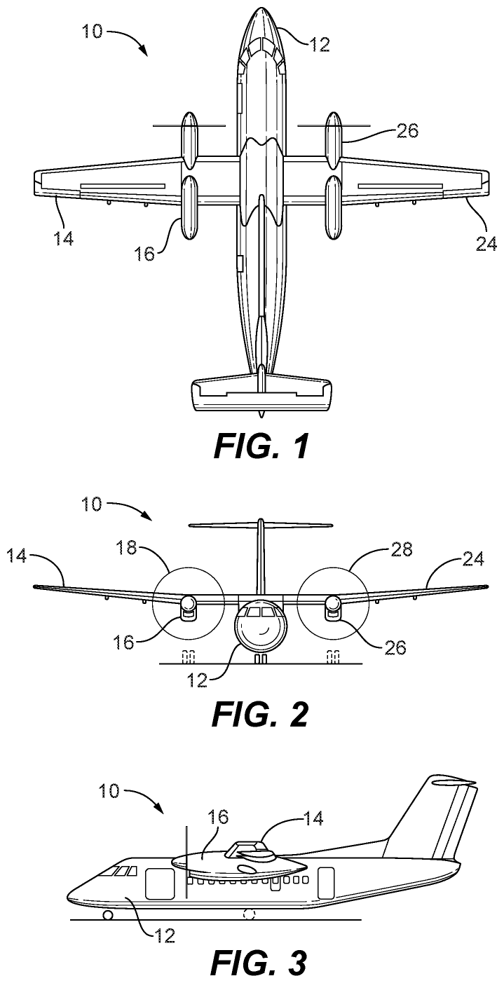

Referring now to the drawings wherein like reference numeral identify similar structure or features of the subject invention, there is illustrated in FIGS. 1 through 3 a commercial passenger aircraft 10 having a propulsion system that is configured in accordance with a preferred embodiment of the subject invention.

The aircraft 10 includes a fuselage 12 designed to carry passengers, a left wing 14 and a right wing 24. The left wing 14 supports a first engine nacelle 16 for housing a combustion powerplant that delivers power to a first air mover or a propeller 18 to propel the aircraft 10. The right wing 24 supports a second engine nacelle 26 for housing a hybrid-electric powerplant that delivers power to a second air mover or a propeller 28 to propel the aircraft 10.

The propulsion system of aircraft 10 is the result of a modification to an existing aircraft propulsion system having dual combustion powerplants, wherein a gas turbine turboprop engine was associated with both the left wing 14 of the aircraft 10 and the right wing 24 of the aircraft 10. As described in more detail below, by replacing the combustion powerplant associated with the right wing 24 of the aircraft 10 with a hybrid-electric powerplant, fuel consumption by the propulsion system of the aircraft 10 is demonstrably reduced.

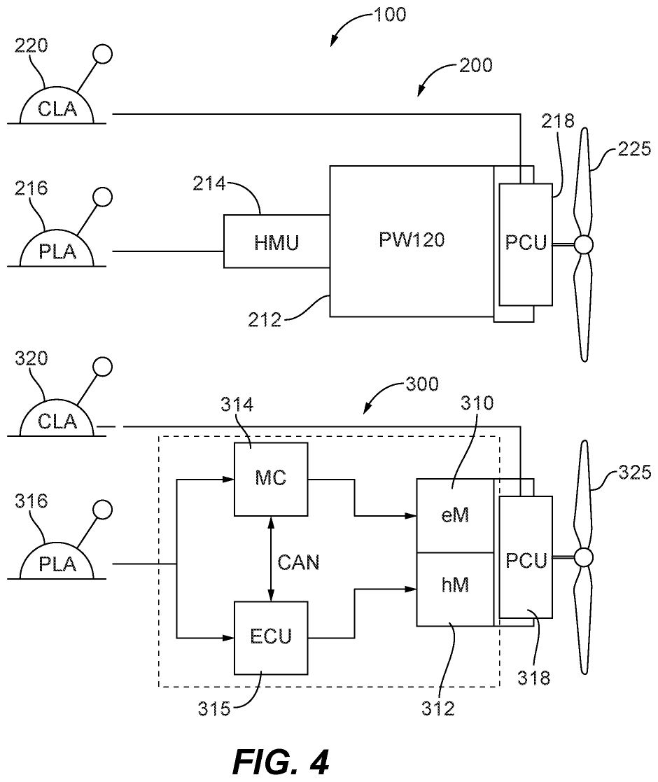

FIG. 4 illustrates the propulsion system of the subject invention, which is designated generally by reference numeral 100. The propulsion system 100 includes a combustion powerplant 200 and a hybrid-electric powerplant 300. The combustion powerplant 200 is located in the nacelle 16 on the left wing 14 of the aircraft 10 and it includes a conventional heat engine, such as a gas turbine turboprop engine 212 or the like.

For example, the combustion powerplant could include a PW 120 turboprop engine manufactured by Pratt & Whitney Canada, for delivering power to an air mover or propeller 225, as in the case of a DHC-8 or Dash 8 series aircraft. A turboprop engine, such as a PW 120 turboprop engine, is a variant of a jet engine that has been optimized to drive a propeller. It incorporates a compressor, combustor and turbine within the gas generator of the engine. An additional turbine drives a power shaft and a reduction gearbox to drive the propeller.

A Hydro-mechanical Fuel Control Unit (HMU) 214, which operates in conjunction with an electronic control unit, schedules fuel flow to the turboprop engine 212 in response to control input from the pilot by way of a Power Lever Angle (PLA) throttle 216 or a similar electro-mechanical controller located on the flight deck of the aircraft 10. The combustion powerplant 200 further includes a Propeller Control Unit (PCU) 218 that receives input from the pilot by way of a Condition Lever Angle (CLA) throttle 220 or a similar electro-mechanical controller located on the flight deck of the aircraft 10.

The CLA throttle 220 controls such functions as fuel cut-off, propeller feathering, propeller un-feathering, low idle/high idle selection, and propeller speed control. The condition lever may have two or more detents corresponding to specific RPM settings (i.e. takeoff, climb and cruise settings) or the lever may allow setting the propeller RPM to any value within an allowable range.

The hybrid-electric powerplant 300 of propulsion system 100 has two power lanes that deliver power to an air mover or propeller 325. One power lane includes an electric motor (eM) 310 and the other power lane includes a heat engine (hM) 312. The electric motor 310 and the heat engine 312 of the hybrid-electric powerplant 300 can be arranged in a parallel drive configuration or an in line drive configuration, depending upon the application. Power can be evenly split between the electric motor 310 and the heat engine 312 (i.e., a split of 50% electric motor power and 50% heat engine power), or power can be divided proportionally between the electric motor 310 and the heat engine 312 (e.g., any split from 10% electric motor power to 90% heat engine power or vice versa).

It is envisioned that the electric motor 310 would be designed to output up to 1 MW or more of shaft power to propeller 325, with an output shaft speed of 12,000 RPM, or at any speed for the best combination of power density, heat management and efficiency. The electric motor 310 could include distributed winding or concentrated windings.

It is also envisioned that battery system would provide energy to the electric motor 312 of the hybrid-electric powerplant 300. The battery system could be located within the fuselage 12 of the aircraft 10 and/or within the wings 14, 24 of the aircraft 10, or in any other optimum location for space availability and proximity of use.

It is further envisioned that the heat engine 312 of the hybrid-electric powerplant 300 could be a heat engine of any type, e.g., a gas turbine, spark ignited, diesel, rotary or reciprocating engine of any fuel type with a configuration of turbomachinery elements, selected from a group consisting of a turbocharger, turbo-supercharger, or supercharger and exhaust recovery turbo compounding, which is mechanically, electrically, hydraulically or pneumatically driven. An example of a rotary engine suitable for this application is disclosed in U.S. Pat. No. 10,145,291, the disclosure of which is herein incorporated by reference in its entirety.

The hybrid-electric powerplant 300 further includes a Motor Controller (MC) 314 and an Engine Control Unit (ECU) 315 which communicate with one another by way of communication Bus, such as a CAN Bus or similar communication network. The hybrid electric powerplant 300 receives control input from the pilot by way of a Power Lever Angle (PLA) throttle 316 located on the flight deck of the aircraft 10. The hybrid-electric powerplant 300 further includes a Propeller Control Unit (PCU) 318 that receives input from the pilot by way of a Condition Lever Angle (CLA) throttle 320 located on the flight deck of the aircraft 10.

As described above, the propulsion system of aircraft 10 is the result of a modification to an existing aircraft propulsion system having dual combustion powerplants. Thus, the subject invention is also directed to a method of retrofitting an aircraft having a propulsion system with dual combustion powerplants.

The method involves the steps of removing one of the combustion powerplants 200 from the aircraft 10, and then replacing the combustion powerplant 200 that has been removed from the aircraft 10 with a hybrid-electric powerplant 300, such that the aircraft 10 has a combustion powerplant 200 associated with one wing and a hybrid-electric powerplant 300 associated with the other wing.

The subject invention is also directed to a method of retrofitting an aircraft 10 having a propulsion system with two combustion powerplants 200, which includes the steps of removing the existing combustion powerplants 200 from the aircraft 10, and installing two hybrid-electric powerplants 300 on the aircraft 10, to improve the fuel efficiency of the propulsion system.

While the systems and methods of the subject invention has been described with reference to preferred embodiments, those skilled in the art will readily appreciate that changes and/or modifications may be made thereto without departing from the spirit or scope of the subject disclosure.

What is claimed is:

1. An aircraft propulsion system having dual powerplants, comprising:
a) a combustion powerplant; and
b) a hybrid-electric powerplant.

2. An aircraft proplusion system as recited in claim 1, wherein the combustion powerplant includes a gas turbine turboprop engine.

3. An aircraft proplusion system as recited in claim 1, wherein the hybrid-electric powerplant includes a heat engine and an electric motor.

4. An aircraft proplusion system as recited in claim 3, wherein the heat engine and the electric motor of the hybrid-electric powerplant are arranged in a parallel drive configuration.

5. An aircraft propulsion system as recited in claim 3, wherein the heat engine and the electric motor of the hybrid-electric powerplant are arranged in an in-line drive configuration.

6. An aircraft propulsion system as recited in claim 3, wherein the heat engine of the hybrid-electric powerplant is a gas turbine, a rotary engine or a reciprocating engine of any fuel type with a configuration of turbomachinery elements, selected from a group consisting of a turbocharger, turbo-supercharger, or supercharger and exhaust recovery turbo compounding, which is mechanically, electrically, hydraulically or pneumatically driven.

7. An aircraft propulsion system as recited in claim 3, wherein power delivery from the hybrid-electric powerplant is about evenly split between the heat engine and the electric motor.

8. An aircraft propulsion system as recited in claim 3, wherein power delivery from the hybrid-electric powerplant is proportionally split between the heat engine and the electric motor.

9. An aircraft proplusion system as recited in claim 1, wherein the combustion powerplant delivers power to a first air mover for propelling the aircraft and the hybrid-electric powerplant delivers power to a second air mover for propelling the aircraft.

10. An aircraft proplusion system as recited in claim 3, wherein a battery system provides energy to the electric motor of the hybrid-electric powerplant.

11. An aircraft proplusion system as recited in claim 10, wherein the battery system is located with the fuselage and/or wings of the aircraft.

12. An aircraft having a propulsion system with dual powerplants, comprising:
a) a combustion powerplant associated with a first wing of the aircraft that delivers power to a first air mover for propelling the aircraft; and
b) a hybrid-electric powerplant associated with a second wing of the aircraft that delivers power to a second air mover for propelling the aircraft.

13. An aircraft as recited in claim 12, wherein the combustion powerplant includes a turboprop engine.

14. An aircraft as recited in claim 12, wherein the hybrid-electric powerplant includes a heat engine and an electric motor that are arranged in a parallel drive configuration.

15. An aircraft as recited in claim 12, wherein the hybrid-electric powerplant includes a heat engine and an electric motor that are arranged in an in-line drive configuration.

16. An aircraft as recited in claim 12, wherein power delivery from the hybrid-electric powerplant is about evenly split between the heat engine and the electric motor.

17. An aircraft as recited in claim 12, wherein power delivery from the hybrid-electric powerplant is proportionally split between the heat engine and the electric motor.

18. An aircraft as recited in claim 12, wherein the heat engine of the hybrid-electric powerplant is a gas turbine, a rotary engine or a reciprocating engine of any fuel type with a configuration of turbomachinery elements selected from a group consisting of a turbocharger, turbo-supercharger, or supercharger and exhaust recovery turbo compounding, which is mechanically, electrically, hydraulically or pneumatically driven.

19. A method of retrofitting an aircraft having a propulsion system with dual combustion powerplants, comprising:
a) removing a combustion powerplant from the aircraft; and
b) replacing the combustion powerplant that has been removed from the aircraft with a hybrid-electric powerplant, such that the aircraft has a combustion powerplant associated with one wing and a hybrid-electric powerplant associated with the other wing.

20. A method of retrofitting an aircraft having a propulsion system with combustion powerplants, comprising:
a) removing the existing combustion powerplants from the aircraft; and
b) installing hybrid-electric powerplants on the aircraft, to improve the fuel efficiency of the propulsion system.
